(19) United States
(12) Patent Application Publication
(10) Pub. No.: US 2025/0077726 A1
(43) Pub. Date: Mar. 6, 2025

(54) METHOD FOR CONFIGURING A TECHNICAL SYSTEM TO BE CONFIGURED

(71) Applicant: Robert Bosch GmbH, Stuttgart (DE)

(72) Inventors: Felix Berkenkamp, Muenchen (DE); Kathrin Skubch, Frankfurt (DE); Paul Sebastian Baireuther, Stuttgart (DE); Petru Tighineanu, Korntal-Muenchingen (DE)

(21) Appl. No.: 18/815,942

(22) Filed: Aug. 27, 2024

(30) Foreign Application Priority Data
Sep. 4, 2023 (DE) 10 2023 208 510.0

(51) Int. Cl. G06F 30/17

(52) U.S. Cl. CPC G06F 30/17

(57) ABSTRACT

A method for configuring a technical system. The method includes: detecting reference observations; conditioning reference system models on the reference observations detected for the reference system; detecting observations of results of the technical system to be configured for different values of the configuration parameters; adjusting an a priori model for the relationship between the values of the configuration parameters and the results provided by the technical system to the observations detected for the technical system, wherein the a priori model is formed from a weighted combination of the conditioned reference system models; ascertaining an a posteriori model for the relationship between the values of the configuration parameters and the results provided by the technical system by conditioning the adjusted a priori model on the observations detected for the technical system to be configured; and configuring the technical system using the ascertained a posteriori model.

### CROSS REFERENCE

The present application claims the benefit under 35 U.S.C. § 119 of German Patent Application No. DE 10 2023 208 510.0 filed on Sep. 4, 2023, which is expressly incorporated herein by reference in its entirety.

### FIELD

The present invention relates to a method for configuring a technical system to be configured.

### BACKGROUND INFORMATION

In production processes and machining processes (e.g., drilling, milling, heat treatment, etc.), process parameters such as a process temperature, a process time, a vacuum or a gas atmosphere etc., are set such that desired properties, such as hardness, strength, thermal conductivity, electrical conductivity, density, microstructure, macrostructure, chemical composition, etc., of a workpiece are achieved. The process parameters can be ascertained by model-based optimization methods, such as Bayesian optimization methods. Here, a model for the production or machining process can be ascertained based on measurement data. However, this can require large quantities of measurement data and therefore high expenditure (e.g., time expenditure and/or costs). This expenditure can be reduced by ascertaining the model based on a model already learned that describes a process related to the production or machining process in conjunction with the measurement data (also referred to as transfer learning). For example, both models can describe drilling or milling on different machines (and with comparable process parameters). The model already learned can serve as a basis for the model to be learned and therefore reduce the required quantity of measurement data. Efficient procedures are desirable for this purpose.

### SUMMARY

According to various example embodiments of the present invention, a method for configuring a technical system to be configured is provided, comprising:
detecting, for each one or more technical reference systems, reference observations of results of the reference system for different values of configuration parameters (i.e., the relationship of what results the reference system provides if it is configured with respective one or more values for the one or more configuration parameters);
conditioning, for each reference system, a relevant reference system model for the relationship between the values of the configuration parameters and the results provided by the reference system on the reference observations detected for the reference system;
detecting, for the technical system to be configured, observations of results of the technical system to be configured for different values of the configuration parameters;
adjusting an a priori model for the relationship between the values of the configuration parameters and the results provided by the technical system to be configured to the observations detected for the technical system to be configured (e.g., using a likelihood approach), wherein the a priori model is formed from a weighted combination of the conditioned reference system models;
ascertaining an a posteriori model for the relationship between the values of the configuration parameters and the results provided by the technical system to be configured by conditioning the adjusted a priori model on the observations detected for the technical system to be configured; and
configuring the technical system to be configured using the ascertained a posteriori model (e.g., so that a desired result is achieved with the values of the configuration parameters according to the a posteriori model).

The technical reference systems can be very similar to the system to be configured, to the extent that they differ in variations caused by the fact that the system to be configured and a reference system are physically the same system, but are operated at different times (as a result of which differences arise, e.g., due to temperature, air pressure, available bandwidth or computing power, etc.).

The detection of observations for the technical system to be configured does not necessarily have to take place after the reference system models have been conditioned, but can also take place at least partially beforehand. The conditioning of the a priori model can also include successive conditioning on the basis of successive observations (e.g., evaluations according to an acquisition function).

The method described above can be used in particular to optimize black box functions. Black box functions are functions in which the gradients of the function are not available. Therefore, optimization algorithms based on gradient descent are not directly applicable. In addition, functional evaluations can be distorted by noise (e.g., measurement noise). However, data from related black box functions is often available to support the optimization, e.g., data from previous optimizations for related tasks. The method described above enables efficient use of such so-called metadata in the optimization process (in terms of data efficiency, computational complexity and scalability in the number of meta-tasks). In particular, a “warm start” of a Bayesian optimization of a function on the basis of metadata is made possible.

One possible application of the method is parameter optimization in an industrial environment, e.g., the optimization of a physical (production) process. A typical example is a laser welding process, with which two workpieces are to be joined together using a laser beam by temporally and locally melting the workpieces. Here, parameters such as the laser power and laser spot diameter are exemplary process parameters that need to be optimized. For such an optimization, it is typically necessary to execute the process and analyze the results at different parameter settings in costly and time-consuming experiments. Therefore, it is desirable to select the parameters at which these experiments are performed in an informed manner and to use the available information efficiently and effectively, with the goal of achieving a sufficiently good parameter setting with as few experiments as possible. Other applications are, for example, the optimization of hyperparameters in an algorithm (e.g., the number of hidden layers in a neural network) or the efficient calibration (and thus configuration) of a physical (in particular a technical) system.

The method can also be used for active learning. Active learning typically aims to model one or more target variables over an entire subset of the parameter space. Such a model can then be used to, e.g., operate a system. For example, if the relationship between the input voltage and the rotational speed of a motor is known, the voltage can be set by model inversion, so that a desired rotational speed is achieved.

Various exemplary embodiments of the present invention are specified below.

Exemplary embodiment 1 is a method for configuring a technical system to be configured, as described above.

Exemplary embodiment 2 is a method according to exemplary embodiment 1, wherein adjusting the a priori model comprises adjusting the weights of the weighted combination of the conditioned reference system models.

In this way, account can be taken of how well findings from one of the related configuration tasks (i.e., the configuration of the reference systems) can be transferred to the configuration of the technical system to be configured.

Exemplary embodiment 3 is a method according to exemplary embodiment 1 or 2, wherein the conditioned reference system models and the a priori model for the system to be configured are Gaussian processes.

This enables efficient modeling, conditioning and combination of the reference system models to form the a priori model for the system to be configured.

Exemplary embodiment 4 is a method according to exemplary embodiment 3, wherein the covariance function (also referred to herein by the usual term “kernel”) of the a priori model consists of a weighted sum of the covariances of the reference system models (i.e., the weighted combination includes the weighted sum of the covariances, i.e. the weights of the weighted combination determine the weights of the weighted sum of the covariances) and a residual covariance function, wherein adjusting the a priori model comprises adjusting the residual covariance function.

Thus, relationships for the technical system to be configured that are not included in the reference system models can be modeled.

The mean value of the a priori model is given, for example, by a weighted sum of the mean values of the reference system models (wherein the weight of the mean value of a reference system model and the weight of the covariance of the reference system model can depend on each other, e.g. the weight of the covariance of the reference system model is the square of the weight of the mean value of a reference system model).

Exemplary embodiment 5 is a method according to exemplary embodiment 3 or 4, wherein the weight of a first reference system model of the reference system models is ascertained by projecting the observations detected for the technical system to be configured onto the mean value of the first reference system model, and the weight of a second reference system model of the reference system models is ascertained by projecting a residual of the observations detected for the technical system to be configured (i.e., minus the part described by the projection of the observations onto the mean value of the first reference system model).

This enables the weights to be ascertained with significantly less effort than a likelihood estimate, in particular for a large number of reference systems, and thus more rapid training.

For a further reference system model, the remaining part of the observation (which is not yet covered by the previous projection) can then be projected onto the mean value of the reference system model (see Algorithm 2 below).

Exemplary embodiment 6 is a method according to one of exemplary embodiments 1 to 5, comprising, for each reference system, generating the reference system model by adjusting a relevant reference a priori model to the observations detected for the reference system (e.g., by means of a likelihood approach).

This increases the quality of the reference system models. The conditioning of the reference a priori models on the respective observations then provides a posteriori models for the reference systems.

Exemplary embodiment 7 is a data processing device (in particular a control device) that is designed to perform a method according to one of exemplary embodiments 1 to 6.

Exemplary embodiment 8 is a computer program comprising commands that, when executed by a processor, cause the processor to perform a method according to one of exemplary embodiments 1 to 6.

Exemplary embodiment 9 is a computer-readable medium storing commands that, when executed by a processor, cause the processor to perform a method according to one of exemplary embodiments 1 to 6.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a system for performing a physical or chemical process.

FIG. 2 illustrates the functionality of a meta-learning model according to one example embodiment of the present invention.

FIG. 3 shows a flowchart illustrating a method for configuring a technical system to be configured according to one example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed.

Other aspects may be used and structural, logical, and electrical changes may be performed without departing from the scope of the present invention. The various aspects of this disclosure are not necessarily mutually exclusive, since some aspects of this disclosure may be combined with one or more other aspects of this disclosure to form new aspects.

Various examples are described in more detail below.

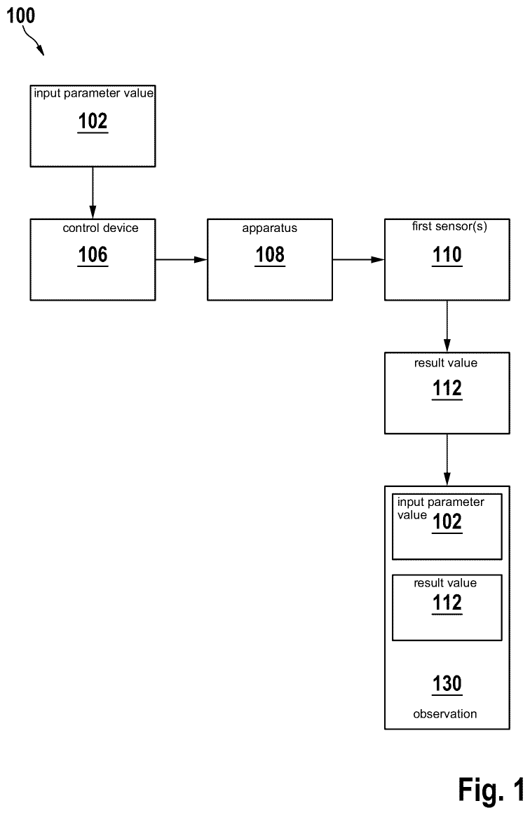

FIG. 1 shows a system 100 comprising an apparatus 108 that is designed to execute a physical or chemical process.

The physical or chemical process can be any type of technical process, such as a manufacturing process (e.g., producing a product or intermediate product), a machining process (e.g., machining a workpiece), a control process (e.g., moving a robot arm) or a measuring process. Such a physical process typically has to be controlled, in particular configured (set), e.g. a measuring apparatus has to be calibrated, etc. For example, it may be necessary to set various control variables of an apparatus (e.g., as part of a calibration) in order to perform a physical or chemical process. For example, the physical or chemical process in a heat treatment by means of a furnace can require a calibration of the furnace temperature and/or the vacuum. The corresponding configuration of the apparatus 108 (i.e., the performing of the corresponding configuration task) is effected by a control device 106.

Two physical or chemical processes and thus the respective configuration tasks can be related to one another in different ways. For example, it can be substantially the same process twice, such as the drilling or milling of components, but executed by means of different machines. Even the same process on different machines can lead to individual results. Two processes executed on the same machine can also be related to one another. For example, one process can be drilling a metal component and another process can be drilling a ceramic component. In general, two processes or configuration tasks can be related to one another if the input variables of the relevant process or configuration task overlap at least partially and the output variables of the relevant process or configuration task overlap at least partially. Illustratively, two processes related to one another can have one or more identical input variables (e.g., a process temperature, a process time and/or a vacuum pressure in the case of a heat treatment), which are set in the relevant configuration task, and one or more identical output variables (e.g., a hardness, strength, density, microstructure, macrostructure and/or chemical composition in the case of a heat treatment). Two processes or configuration tasks are related to one another if their respective models are suitable for transfer learning.

In the following, it is assumed that the control device 106 is to execute a target (configuration) task, e.g. a configuration for a certain physical or chemical process to be performed by the apparatus 108, and that one or more processes and configuration tasks related to this target task have already been executed by the system or also by one or more other (at least similar) systems. For example, these are physical or chemical processes related to the certain physical or chemical process, and the corresponding configuration tasks are the configurations (e.g., of the apparatus 108) for performing these processes. However, a configuration task can also be (instead of setting parameters for a physical or chemical process), for example, the configuration of a relevant machine learning model (i.e., setting hyperparameters, e.g. of a neural network). Accordingly, the target task is generally referred to as a (target) configuration task for a technical system (wherein the configuration can refer to process parameters or hyperparameters for a machine learning model, etc.). The associated (i.e. related) target tasks can be generally related (configuration) tasks (for other (“related”) technical systems, also referred to herein as “reference” systems) or also so-called “meta” or “reference” (configuration) tasks (for related processes as described above or also the earlier configuration of neural networks, e.g. for similar tasks (e.g., classification of other types of objects than in the target task) etc.).

Accordingly, the apparatus 108 can be a machine, but also a data processing apparatus or part thereof (e.g., a program part that implements a neural network), etc.

The control device 106 is configured to control the first apparatus 108 according to a relevant (provided) input parameter value 102 of at least one (i.e., exactly one or more than one) input variable (e.g., temperature, exposure time but also hyperparameters etc.). Therefore, an input parameter value 102 is also understood herein to be a vector with values that includes values for a plurality of settable variables (e.g., process parameters).

Illustratively, the control device 106 can, for example, control an interaction of the apparatus 108 with the environment according to the input parameter value 102.

The term “control device” (also referred to as “controller”) can be understood as any type of logical implementation unit that can include, for example, a circuit and/or a processor capable of executing software, firmware, or a combination thereof stored in a storage medium, and issue the instructions, e.g., to an apparatus for executing a process in the present example. The control device can be configured, for example, by means of program code (e.g., software), to control the operation and/or setting (e.g., calibration) of a system, such as a production system, a processing system, a robot, etc.

An input parameter value as used herein can be a parameter value describing an input variable such as a physical or chemical variable, an applied voltage, an opening of a valve, etc. For example, the input variable can be a process-relevant property of one or more materials, such as hardness, thermal conductivity, electrical conductivity, density, microstructure, macrostructure, chemical composition, etc. However, as described above, the input parameter value can also be a hyperparameter (e.g., a number of layers of a neural network or their size) or the like.

During or after execution of the target task or the relevant related task according to the respective input parameter values 102, a result of the relevant task is ascertained.

For this purpose, the system 100 can have one or more sensors 110, for example. The one or more first sensors 110 can be designed to detect a result of the target task, in particular of a physical or chemical process. A result of the process can, for example, be a property of a produced product or machined workpiece (e.g., a hardness, strength, density, microstructure, macrostructure, chemical composition, etc.), a success or failure of a skill (e.g., picking up an object) of a robot, a resolution of an image recorded by means of a camera, etc. The result of the process can be described by means of at least one (i.e., exactly one or more than one) output variable. The one or more first sensors 110 can be designed to detect the at least one output variable and thus ascertain a result value 112. Like the input parameter value, this can be a vector with a plurality of components; for example, a relevant value for each output variable of a plurality of output variables can be detected.

The detection of a result of a process by means of one or more sensors as described herein can take place while the process is executed (in situ) and/or after the process is executed (ex situ). For example, the model can describe the relationship between one or more input variables and at least two output variables, it being possible to detect an output value of an output variable of the at least two output variables during the process and an output value of the other output variable of the at least two output variables after the process has been executed. As an illustrative example of detecting the output value after the process has been executed, the process can be hardening a workpiece in a furnace with a temperature as an input variable. In this case, the output variable can be a hardness of the workpiece at room temperature after the hardening process. The output variable can have an application-specific quality criterion. The output variable can be a component-related parameter, such as a measure or a layer thickness, or can be a material-related parameter, such as hardness, thermal conductivity, electrical conductivity, density, chemical composition, etc.

In the case where the relevant task is the configuration of a relevant neural network, the output value 112 can also be ascertained without sensors, for example by assessing the accuracy of the neural network that has been configured according to the relevant input parameter value.

A result value can be a value describing an output variable of the process. An output variable of the process can be a property of a product, workpiece, recorded image or another result. However, an output variable of the process can also be a success or failure (e.g., of a skill of a robot). Illustratively, the result value 112 results from the input parameter value 102.

However, the relationship between the input parameter value 102 and result value 112 is typically very complex and unknown. A pair consisting of an input parameter value 102 and associated result value 112 forms an observation (or “data point”) 130.

If x designates the input parameter value 102 and y designates the result value 112, then for the target task (indexed with the index t for “target”) y=fₜ(x), and for the related tasks (indexed with indices m for “meta”) y=fₘ(x), where both fₜ and fₘ are unknown.

A typical task is now to maximize fₜ (wherein in the following it is assumed that the result value has only one real component), i.e. to find an x for which the result value is as good as possible (e.g., maximum). In order to increase the efficiency of such an optimization, according to various embodiments, knowledge of the related tasks is used, i.e. so-called “meta-learning” (or “transfer learning”) is used, which can drastically reduce the number of experiments required for the target task. It should be noted that the goal need not necessarily be to optimize fₜ, but it may also be desirable to find a model for fₜ, for which the approach described below can also be used. However, it is assumed in the following that fₜ is to be optimized (specifically maximized).

Thus, in the following, a meta-learning situation is considered in which the goal is to efficiently maximize a function fₜ: D→ [symbol] (where D is a relevant space of possible input parameter values for the configuration), where fₜ is unknown (e.g., is a sample from an unknown distribution of functions). In order to maximize fₜ, parameters (i.e., input parameter values) xₙ can be sequentially evaluated to obtain noisy observations yₙ=fₜ(xₙ)+ωₙ, where ωₙ˜N(0,σₜ²) represents Gaussian noise with a mean value of zero and is independently and identically distributed. It should be noted that the approach described herein is not restricted to applications in which this assumption is fulfilled. In practice, this assumption is usually violated, but the regression method with Gaussian processes often works well nonetheless. For example, this assumption is also made for linear regression by means of the least squares method.

For this purpose, Nₜ observations from previous executions of the target task [symbol] ={xₙ,yₙ}ₙ₌₁^{N}^{ₜ} can be used in order to create a probabilistic model for fₜ. According to various embodiments, a Gaussian process is used as a model, i.e. fₜ˜ [symbol] [symbol] (m,k). A Gaussian process models different function values via a common Gaussian distribution, which is parameterized by a mean value vector and a covariance matrix.

The a posteriori Gaussian process (hereafter simply referred to as posterior), which is obtained by conditioning an a priori Gaussian process (hereafter simply referred to as prior) for fₜ with mean value function m(•) and kernel (i.e. covariance function) k(•, •) on data [symbol] ₜ, is a Gaussian process with a mean value and a covariance given by

$${μ}_{t} ( x ) = m ( x ) + k ( x , {X}_{t} ) {( k ( {X}_{t} , {X}_{t} ) + {σ}_{t}^{2} I )}^{- 1} ( {y}_{t} - m ( x ) ) , \qquad ( 1 )$$

$${\sum }_{t} ( x , {x}^{′} ) = k ( x , {x}^{′} ) - k ( x , {X}_{t} ) {( k ( {X}_{t} , {X}_{t} ) + {σ}_{t}^{2} I )}^{- 1} k ( {X}_{t} , {x}^{′} ) ,$$

where Xₜ=(x₁, . . . , x_{Nt}) and yₜ=(y₁, . . . , y_{Nt}) is the vector of the corresponding noisy result values.

With Bayesian optimization, the posterior, characterized by (1), is used to sequentially query the result to form a new parameter x_{Nt+1}, which provides information about the optimum of fₜ by solving an auxiliary optimization problem on the basis of an acquisition function α,

$${x}_{{N}_{t} + 1} = {arg max}_{x ∈ D} α ( {f}_{t} \vert x , {t}_{} , {1 : M}_{} ) \qquad ( 2 )$$

The performance of this approach typically depends on the quality of the prior. According to various embodiments, in particular, an approach is provided that enables a prior with good quality to be ascertained. Observations (“metadata”) from the related tasks are used for this purpose. The relationship between the input parameter 102 and result value 112 for the related tasks is given by functions fₘ (which, e.g., originate from the same distribution of functions as fₜ).

It is therefore assumed that for each related task (index m, m∈ [symbol] ={1, . . . , M}) there is access to a relevant data set [symbol] ₘ={x_{m,n}, y_{m,n}}n₌₁^{N}^{ₘ}, which is based on Nₘ noisy observations y_{m,n}=fₘ(x_{m,n})+ω_{m,n} of the relevant task which are distorted by different noise levels ω_{m,n}˜ [symbol] (0,σₘ²) (but this is not necessary). Together, these data sets form the metadata [symbol] _{1:M}= [symbol] .

This metadata can be incorporated into Gaussian process modeling by considering a common model across the target task and related tasks. Such a multi-task GP model (MTGP) is defined by an extended kernel that additionally models similarities between the tasks,

$$k ( ( x , v ) , ( {x}^{′} , {v}^{′} ) ) = {[ {W}_{m} ]}_{( v , {v}^{′} )} {k}_{m} ( x , {x}^{′} ) \qquad ( 3 )$$

where kₘ are arbitrary kernel functions and Wₘ are positive semidefinite matrices that are called coregionalization matrices, since their entries [Wₘ]_{(ν,ν′)} model the covariances between two tasks ν and ν′. By means of conditioning (i.e., “determining” in the sense of a conditional probability) this common model on [symbol] _{1:M} and [symbol] ₜ, a narrower posterior for fₜ can be obtained by the GP equations of (1). However, these multi-task GP models are both computationally intensive (cubic in the number of all meta and task points) and difficult to train in practice due to the large number of hyperparameters.

For the sake of simplicity, the target task is referred to below as the M+1-th task, i.e. t=M+1. A key challenge in learning an MTGP model with (3) is that learning covariances on the basis of few data points is difficult, which generally leads to poor performance. For this reason, the joint use of hyperparameters is often introduced in practice. However, this does not reduce the computing costs for evaluating the model.

The following describes an MTGP meta-learning model that can be both efficiently trained and evaluated. Instead of the typical parameter partitioning, two assumptions are introduced for the common GP model of (3), which restrict learning to the most important covariances and lead to a modular GP posterior model that can be evaluated efficiently.

First, correlations between the meta-tasks are neglected, since it can be difficult (or even impossible) to learn them if only a small amount of metadata is available for each meta-task. For the sake of simplicity, the covariance between the tasks used is written Cov(fₘ, f_{m′})=c for one c≥0 instead of the more explicit Cov (fₘ(x), f_{m′} (x′))=c kₘ(x, x′).

Assumption 1: Cov (f_{1:M}, f_{1:M})=I.

Note that although this limits the transfer of information between the meta-tasks, each meta-task can still influence the target task. Consequently, after conditioning on the observations of the target tasks [symbol] ₜ, the meta-tasks can still be correlated. The assumption that Cov(fₘ, fₘ)=1 (for m=1 . . . M) ensures that each kernel kₘ in (3) models the marginal distribution for the model of the corresponding meta-task fₘ. Taken together, these two properties are crucial for being able to efficiently learn the provided model even for a large number M of meta-tasks, since it enables models to be learned independently for each meta-task, which are then combined to form a prior for the target task.

Second, the model provided is constrained to the effect that it is assumed that fₜ is additive in the meta-task functions, i.e., additive in functions that (anti-)correlate perfectly with the meta-task models. The short notation Corr (fₘ, f_{m′})=Corr(fₘ(x), f_{m′} (x)) is used for the correlation coefficients.

Assumption 2: The function fₜ can be written as follows:

fₜ=\tilde{f}ₜ+ [symbol] \tilde{f}ₘ, where

|Corr(\tilde{f}ₘ,fₘ)|=1, Cov(\tilde{f}ₜ,fₜ)=1 and Cov(\tilde{f}ₜ,fₘ)=0 for all m∈ [symbol] .

In particular, for the MTGP model in (3), Cov(fₘ,\tilde{f}ₘ)=[Wₘ]_{(m,t)}.

By constraining the components \tilde{f}ₘ of the target task model so that they correlate perfectly with the meta-task models, the intuition that parts of the meta-task functions are to be reflected in the target task is modeled directly. As a result, only the scalings of these functions remain as free parameters that can be learned.

This ensures that the model provided has a structured prior for the target task. The residual component \tilde{f}ₜ is independent of the meta-tasks and aims to model all parts of the target task that cannot be explained by the metadata.

Together, assumptions 1 and 2 force a structuring of the coregionalization matrices in (3). Assumption 1 forces that [Wₘ]_{(m,m′)} is zero if m≠m′, while assumption 2 directly forces [W]_{m,m}=1, so that the variation of each meta-task is directly modeled by the corresponding kernel kₘ. The assumption about the correlation additionally leads to matrices Wₘ which are characterized by a single, scalar and unconstrained parameter wₘ∈ [symbol] for each meta-task m∈ [symbol] . Specifically, the matrix elements are all zero except

$${[ {W}_{t} ]}_{( t , t )} = {[ {W}_{m} ]}_{( m , m )} = 1 , {[ {W}_{m} ]}_{( m , t )} = {[ {W}_{m} ]}_{( t , m )} = {w}_{m} , {[ {W}_{m} ]}_{( t , t )} = {w}_{m}^{2} . \qquad ( 4 )$$

For a meta-task M=1, for example, the following applies:

$${W}_{1} = [ \begin{matrix}1 & {w}_{1} \\ {w}_{1} & {w}_{1}^{2}\end{matrix} ] , {W}_{t} = [ \begin{matrix}0 & 0 \\ 0 & 1\end{matrix} ]$$

Based on this example, it is easy to verify that both matrices are positive semidefinite and that

$$\vert Corr ( {\tilde{f}}_{1} , {f}_{1} ) \vert = \vert {w}_{1} / \sqrt{{1}^{2} \times {w}_{1}^{2}} \vert = 1$$

While, with the model provided, the function of the meta-task fₘ and the corresponding component \tilde{f}ₘ in the function of the target task fₜ are restricted to a perfect correlation, the size of wₘ determines the extent to which the meta-task is relevant for the target task: The prior for fₜ is given by μ₁ and w₁²k₁(⋅,⋅)+kₜ(⋅,⋅) and in the limit w₁→0 they are modeled as independent. The same reasoning applies to a plurality of tasks, since the assumptions result in a valid kernel; specifically, it can be shown:

Assumptions 1 and 2 with wₘ∈ [symbol] for m∈ [symbol] provide a valid multi-task kernel, which is given by

$${k}_{ScaML}^{joint} ( ( x , v ) , ( {x}^{′} , {v}^{′} ) ) = {δ}_{v = t} {δ}_{{v}^{′} = t} {k}_{t} ( x , {x}^{′} ) + {g}_{m} ( v ) {g}_{m} ( {v}^{′} ) {k}_{m} ( x , {x}^{′} ) , \qquad ( 5 )$$

where gₘ(ν) equals wₘ if ν=t, is one if ν=m, and zero otherwise. 5 is the Dirac delta. According to (5), a valid common kernel is thus available via meta-tasks and target task, which kernel is parameterized by scalar parameters (weights) wₘ∈ [symbol] . Although this successfully limits the number of parameters, the resulting model generally has the same inference complexity as any other MTGP. However, the common kernel in (5) additionally leads to a specific posterior distribution that enables each meta-task to be modeled as a separate Gaussian process and evaluated efficiently. The following can be shown:

With a Gaussian process prior with a mean value of zero and a multi-task kernel given by (5), the posterior conditioned on the meta-data is given by fₜ| [symbol] _{1:M}˜ [symbol] [symbol] (m_{ScaML},Σ_{ScaML}) with

$${m}_{ScaML} ( x ) = {w}_{m} {μ}_{m} ( x ) , \qquad ( 6 )$$

$${k}_{ScaML} ( x , {x}^{′} ) = {k}_{t} ( x , {x}^{′} ) ) + {w}_{m}^{2} {\sum }_{m} ( x , {x}^{′} ) ,$$

where μₘ(x) and Σₘ(x, x′) are the mean values and covariances of the posterior of the relevant meta-task according to (1) (with indices m instead of t, since (1) is formulated for the target task, but (6) refers to the meta-task), which only depend on [symbol] ₘ.

Thus, each meta-task m can be modeled with an individual Gaussian process on the basis of a kernel kₘ, and the a posteriori mean value μₘ and the a posteriori covariance Σₘ per meta-task can be ascertained by conditioning the relevant Gaussian process on (only) the meta-data of the relevant meta-task [symbol] ₘ. The resulting GP prior distribution for the target task fₜ is given by the weighted sum of the meta-task posteriors according to (6). It is to be noted that the result of the expensive O(Nₘ³) inversion of the kernel matrix can be temporarily stored per meta task, since it only depends on the fixed metadata [symbol] ₘ. Consequently, this approach is suitable for parallelization and efficient evaluation.

A prior is thus obtained for the target task, which can be conditioned by (1) on [symbol] ₜ in order to obtain the posterior for the target task.

$$p ( {f}_{t} \vert x , {m}_{} , {t}_{} ) = 𝒩 ( {μ}_{t} ( x ) , {\sum }_{t} ( x , x ) )$$

This enables not only a complete Bayesian treatment of the uncertainty, but also the determination of the meta-task weights wₘ by a maximum likelihood method.

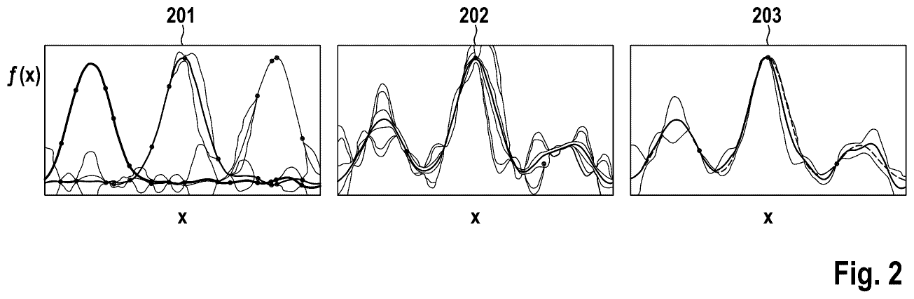

FIG. 2 illustrates the model provided.

The individual meta-task posteriors 201 are combined in a weighted sum with the test task kernel kₜ in order to obtain a target task prior 202 according to (6). This prior is conditioned according to (1) on the target task data [symbol] ₜ in order to obtain the posterior 203 for the target task.

In the above example, it was assumed that the kernel hyperparameters θₘ are given in the various task kernel functions kₘ and the target task hyperparameters θₜ, which include the parameters of kₜ and the weights wₘ. However, according to various embodiments, they are determined in practice from the data [symbol] _{1:M} and [symbol] ₜ by means of likelihood estimation. The direct evaluation of the likelihood of the observed data of the common task model according to (5) is computationally intensive, O((Nₜ+MN̅ₘ)³) with N̅ₘ= [symbol] , since it depends on the data of all tasks. However, any model that fulfills assumption 1 can exploit the model structure in order to scale the number of meta-tasks M, since

$$log p ( {y}_{t} , {y}_{1 : M} \vert {X}_{t} , {X}_{1 : M} , {θ}_{t} , {θ}_{m} ) = log p ( {y}_{t} \vert {1 : M}_{} , {X}_{i} , {θ}_{t} , {θ}_{m} ) + log p ( {y}_{m} \vert {X}_{m} , {θ}_{m} )$$

wherein the second term is the sum of the logarithmic probabilities of the respective meta-data belonging to a meta-task under the relevant meta-task model parameterized by θₘ, which sum can be calculated with the effort O(MNₘ³), while the first term is the likelihood of the prior of the target task. In view of the already inverted meta-task kernel matrices, the calculation of the posterior meta-task covariances on the target task input values Xₜ is associated with the complexity O(M(Nₜ²N̅ₘ+NₜN̅ₘ²)). Together with the resulting target task likelihood, O(Nₜ³), this results in an overall complexity of O(M(\hat{N}ₘ³+Nₜ²N̅ₘ+NₜN̅ₘ²+Nₜ³), which is linear in the number of meta-tasks M and thus enables scalable optimization. In practice, the number of input parameters in Xₜ is typically significantly smaller than that of the available meta-data, since the meta prior already includes important information. This leads to a weak dependency between the meta-model parameters θₘ and the results yₜ of the target task. This is particularly true for the provided model, since the marginal per-task model depends only on kₘ and is thus independent of θₜ.

Accordingly, according to various embodiments, the provided model is modularized by assuming a conditional independence between θₘ and θₜ:

Assumption 3: The following applies to all meta-tasks m∈ [symbol] p(θₘ| [symbol] ₘ, [symbol] ₜ)=p(θₘ| [symbol] ₘ).

While the independence between the meta-tasks is given by assumption 1, assumption 3 goes one step further and allows the meta-task hyperparameters θₘ to be derived independently from the target task hyperparameters θₜ. Thus, the meta-task Gaussian processes can be optimized (i.e., “fitted”) in parallel on the basis of (only) their individual data, according to

$${θ}_{m}^{*} = arg {max}_{{θ}_{m}} log p ( {y}_{m} \vert {X}_{m} , {θ}_{m} )$$

If a relevant meta-task Gaussian process was fitted to the data [symbol] ₘ of a relevant meta-task, the posterior mean value μₘ(Xₜ) and the covariance matrix ∈ₘ(Xₜ,Xₜ) of the meta-task Gaussian process for the target task input parameters Xₜ are calculated and temporarily stored. Since the prior for the target task according to (6) depends on these variables and these do not depend on θₜ due to assumption 3, the parameters θₜ of the model for the target task can then be ascertained by means of likelihood estimation:

$${θ}_{m}^{*} = {arg max}_{{θ}_{t}} log p ( {y}_{t} \vert {1 : M}_{} , {X}_{i} , {θ}_{t} , {θ}_{m}^{*} ) \qquad ( 7 )$$

The effort required for this is O(MNₜ²+Nₜ³), which can be assessed as favorable, especially in the practically relevant range of M≈Nₜ. Since the meta-task Gaussian processes are independent of the target task, they can be calculated once and reused for each new target task. Taken together, this enables scalable meta-learning with Gaussian processes.

Algorithm 1 summarizes the training of the model for fₜ.

Algorithm 1

1: Input: Meta-data [symbol] _{1:M} = [symbol] [symbol] ₘ
2: Train an individual Gaussian process model for each meta-task
(including optimization of θₘ and conditioning on [symbol] ₘ)
3: Construct the target task prior according to (6) and store
μₘ(Xₜ) and Σₘ(Xₜ, Xₜ)
4: Ascertain the target task hyperparameters θₜ according to (7)
5: Condition the target task prior on [symbol] ₜ according to (1)

The training begins in line 2 with the training of an individual Gaussian process model for each meta-task, which are combined in line 3 to form a target task prior. On this basis, the hyperparameters for the target task are optimized in a cost-effective manner in line 4 with the aid of (7). Finally, the posterior is ascertained in line 5 by means of conditioning on [symbol] ₜ according to (1).

As described above, the equations (6) thus provide a scalable and structured way to transfer information from meta-tasks into a new prior for a target task. The key component for this can be seen in assumption 2, which is based on an additive model. While these models reflect many real-life situations, more flexible meta-learning models based on neural networks are in principle capable of learning more complex relationships between the meta and target tasks. However, by relaxing the model assumptions, these methods also require significantly more data. The approach described above is therefore best suited when the amount of data per task is relatively small. While the overall approach scales linearly with the number of meta-tasks and enables parallel optimization, each individual model is still a standard Gaussian process that scales cubically with the number of data points per task. For a large number of data points per task, Nₘ or Nₜ, scalable GP approximations can be used to obtain an efficient inference.

According to one embodiment, a direct calculation of the weights wₘ∈ [symbol] (instead of as part of the likelihood estimation according to (7) or instead of using a separate optimization problem (in the space spanned by the weights)) is performed.

This can be particularly advantageous if there are a large number of meta-tasks and/or a large number of data points for each meta-task. The weights found in this way can then either be used directly or serve as a starting point for a local optimization of the weights.

One approach to this is to consider the posterior mean values of the meta-task models evaluated on the target task input parameter values, μₘ(Xₜ), m∈ [symbol] , as a basis in the space that is spanned by the possible observations of the target task. If this basis were orthonormal, one could simply project the observed target task results yₜ onto this basis and obtain the weights as the portion of the target data vector expressed by the corresponding basis

$${w}_{m} = {y}_{t} \cdot {μ}_{m} ( {X}_{t} ) \qquad ( 8 )$$

However, μₘ(Xₜ), m∈ [symbol] are generally not orthogonal and therefore not orthonormal. However, this problem can be solved with a simple algorithm, as described below.

It starts with the introduction of a vectorial auxiliary variable y=yₜ.

In a first step, w₁=y·\hat{μ}₁(Xₜ) is determined, where \hat{μ}₁(Xₜ)=μ₁(Xₜ)/∥μ₁(X₁)∥. In a second step, the part of y that is described by this first projection is subtracted: The result of this is a residual y→y−w₁\hat{μ}₁(Xₜ). These two steps are repeated for all remaining μₘ(Xₜ), m∈ [symbol] or until a norm of the auxiliary variable falls below a previously defined value. This value can be given in particular by a desired model accuracy. The norm can be given in particular by the L2 or the supremum norm.

Since two basis vectors usually overlap strongly, the weights of the first meta-task models obtained with this method tend to be much larger than the weights corresponding to m>>1. In order to obtain balanced weights, this method can be repeated several times with different orders of the μₘ(Xₜ) and then the average of the weights can be calculated.

Algorithm 2 summarizes the procedure for the direct calculation (or estimation) of the weights. The usual keywords for, do and end are used.

Algorithm 2

| for i = 1 : : Nᵢₜₑᵣₐₜᵢₒₙₛ do | |
|---|---|
| | y = yₜ |
| | Let σ be a random permutation of the indices in M |
| | for σ (m) with m= 1. . M do |
| | ${w}_{σ ( m )}^{i} = y \cdot \frac{{μ}_{σ ( m )} ( {X}_{t} )}{{‖ {μ}_{σ ( m )} ( {X}_{t} ) ‖}_{2}^{2}}$ |
| | y → y − w_{σ(m)}ⁱ μ_{σ(m)} (Xₜ) |
| | Attach w_{σ(m)}ⁱ to a corresponding list (i.e., collect |
| | the results to be sorted and averaged at the end) |
| | end |
| end | |

Average wₘⁱ via i in order to obtain the weights wₘ

As described above, the approach described above can be used to optimize the configuration of a target system 100 (e.g., an apparatus 108 such as a machine). The following is an example of a sequence for optimizing and operating such a target system.
1. Parameterize the target system with a series of parameters X (=parameter vector), which can also be a single parameter. Define a minimum value and a maximum value for each parameter. This information defines the search region S.
   a. Example: The parameters characterize a laser welding process (e.g., laser power, focus position relative to the workpiece)
   b. The parameters characterize a neural network (e.g., number of layers, learning rate)
   c. Variant: The minimum and/or maximum permissible value of a parameter can depend on the values of the other parameters.
   d. Variant: The range of values specified for a parameter can consist of a plurality of intervals.
2. There are M meta-tasks, which are designated with m=1 . . . M. Construct a Gaussian process model for each meta-task. Then train and condition (for each meta-task) this Gaussian process model on the corresponding meta-data [symbol] ₘ in order to obtain the posterior mean values μₘ and covariances Σₘ of the meta-tasks.
   a. Specification: Typically, a Gaussian process is characterized by a kernel, which is often parameterized with hyperparameters that are optimized during the training of the Gaussian process model.
      i. Example: The target kernel is a quadratic exponential kernel or a Matern kernel
      ii. The hyperparameters are length scales and signal variance
3. Define target kernelₖₜ, which can be parameterized by hyperparameters θₜ.
4. Combine all observed target task data points into a target data set [symbol] ₜ⁽ⁿ⁾, where n is the number of data points in the data set. [symbol]
5. Construct a Gaussian process model for the target task with a kernel according to (6). This is the target task prior.
6. IF the target task data set is empty, set all weights to wₘ=1/M kₜ=0.
   OTHERWISE maximize the likelihood of the target task data points according to (7) by jointly varying the weights wₘ and the hyperparameters θₜ of the target task kernel.
   a. Variant: Direct calculation of the weights with algorithm 2, a particularly favorable variant in terms of calculation is Nᵢₜₑᵣₐₜᵢₒₙₛ=1.
7. IF the target task data set is empty, the target task prior in this case is the model for the target task (i.e., for fₜ).
   OTHERWISE condition the target task prior on the target task data set in order to obtain the target task posterior, which in this case is the model for the target task (i.e., for fₜ).
8. Maximize an acquisition function α that uses the target model as a replacement model. The value of the parameter vector that maximizes the acquisition function is xₙ₊₁.
   a. Example: The acquisition function can be the expected improvement, the probability of improvement or the upper confidence limit
   b. Example: For the above acquisition functions, the maximum can be found efficiently by means of gradient descent with a plurality of restarts from different starting points.
9. Configure the target system with the input parameter values xₙ₊₁ and observe result data oₙ₊₁ (which enable an assessment).
   a. Example: The result of optimizing a neural network can be the accuracy of its predictions, which is assessed based on a target data set.
   b. The result of a laser welding process can be assessed, for example, by the width and depth of the resulting weld seam cross-section.
10. Ascertain a scalar value (result value) yₙ₊₁, which characterizes the desirability of the results indicated by the result data.
   a. In the case of a neural network, a higher prediction accuracy is usually desirable.
   b. In the case of a laser welding process, the difference between the observed width and the depth of the weld cross-section from desired reference values should be small.
   c. It can be advantageous to model different desiderata separately. In this case, a plurality of target task data sets and target task models is created. The acquisition function uses all models together as replacement models.
11. Form the (n+1)th data point as pₙ₊₁=(xₙ₊₁,yₙ₊₁) and add it to the target data set.
12. Specify whether the optimization is complete. IF NOT, continue with step 3.
   a. Example: A maximum number of evaluations on the target system can be defined in advance.
13. Select the best input parameter value set in the target task data set (i.e., the one with the best result value) and operate the target system with a configuration given by this input parameter.
   a. Example: The best parameter can be the one for which the scalar value characterizing the desirability of the observed results was maximum.

Within the framework of active learning, the sequence remains substantially the same. The acquisition function in step 8 is selected in such a way that it minimizes the uncertainty of the target model. For example, the acquisition function of the upper confidence limit with a very large exploration margin or more sophisticated acquisition functions such as the entropy of the replacement model could be used. In step 13, instead of selecting the best parameter, the replacement model itself is returned and then used for the desired applications, e.g. to control a motor on the basis of this model.

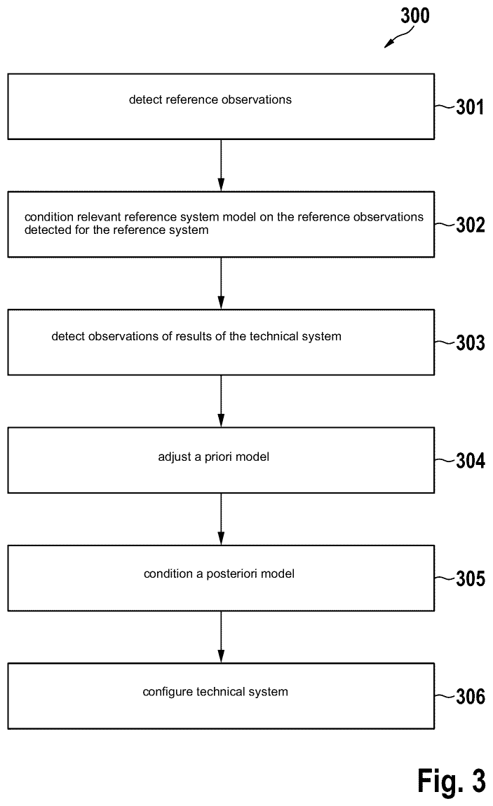

In summary, according to various embodiments, a method as shown in FIG. 3 is provided.

FIG. 3 shows a flowchart 300 illustrating a method for configuring a technical system to be configured according to one embodiment.

In 301, for each one or more technical reference systems, reference observations of results of the reference system for different values of configuration parameters are detected (e.g., measured). Here, it is to be noted that the values of the configuration parameters (and their number) on which the reference observations are based can be different for each reference system. For example, if there were only one configuration parameter p₁, reference system 1 could have been evaluated for p1={0.1; 0.2; 0.5} and reference system 2 for p1={0.3; 0.6}.

In 302, for each reference system, a relevant reference system model for the relationship between the values of the configuration parameters and the results provided by the reference system is conditioned on the reference observations detected for the reference system.

In 303, observations of results of the technical system to be configured are detected (e.g., measured) for different values of the configuration parameters for the technical system to be configured.

In 304, an a priori model for the relationship between the values of the configuration parameters and the results provided by the technical system to be configured is adjusted to the observations detected for the technical system to be configured, wherein the a priori model is formed from a weighted combination of the conditioned reference system models (e.g., as in the example above, supplemented by a residual term kₜ, see equation (5)) (i.e., the a priori model includes the weighted combination of the conditioned reference system models).

In 305, an a posteriori model is conditioned for the relationship between the values of the configuration parameters (considered as configuration parameters for the technical system to be configured—for the whole range of values of the configuration parameters (i.e., not only for the different values of the configuration parameters for which observations of the results have been detected)) and the results provided by the technical system to be configured by conditioning the adjusted a priori model on the observations detected for the technical system to be configured.

In 306, the technical system to be configured is configured using the ascertained a posteriori model.

The results can be detected in the form of one or more output variables. In the case of a plurality of output variables, a separate model can be created for each output variable and the union of these models can then be used as a model. A common goal can be defined in order to consider different goals together in one acquisition function. For example, a cost function is defined, which is then to be minimized by setting the input parameters with the aid of an acquisition function. This cost function combines all target variables in a single scalar function. The cost function can be a sum, for example. Target variables that are to be minimized are included in this sum with a positive sign. Target variables that are to be maximized, accordingly have a negative sign. For target variables that are to reach a certain value, a distance between the target variable and the desired value is included in the cost function. The individual contributions can then be weighted.

The method of FIG. 3 can be performed by one or more computers comprising one or more data processing units. The term “data processing unit” may be understood as any type of entity that enables processing of data or signals. The data or signals can be treated, for example, according to at least one (i.e. one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g. implemented) by a data processing unit by one or more special functions that are performed by the data processing unit.

The method is therefore in particular computer-implemented according to various embodiments.

Various embodiments can receive and use time series of sensor data from various sensors such as video, radar, LiDAR, ultrasound, motion, thermal imaging, currents, voltages, temperatures, etc. (e.g., for the observations). Based on the sensor data, various technical systems, physical devices etc. can be configured, e.g. by a relevant control device.

What is claimed is:

1. A method for configuring a technical system to be configured, comprising the following steps:
detecting, for each one or more technical reference systems, reference observations of results of the reference system for different values of configuration parameters;
conditioning, for each reference system, a respective reference system model for a relationship between values of the configuration parameters and results provided by the reference system on the reference observations detected for the reference system;
detecting, for the technical system to be configured, observations of results of the technical system to be configured for different values of the configuration parameters;
adjusting an a priori model for a relationship between values of the configuration parameters and results provided by the technical system to be configured to the observations detected for the technical system to be configured, wherein the a priori model is formed from a weighted combination of the conditioned one or more respective reference system models;
ascertaining an a posteriori model for the relationship between the values of the configuration parameters and the results provided by the technical system to be configured by conditioning the adjusted a priori model on the observations detected for the technical system to be configured; and
configuring the technical system to be configured using the ascertained a posteriori model.

2. The method according to claim 1, wherein the adjusting of the a priori model includes adjusting weights of the weighted combination of the conditioned at least one or more reference system models.

3. The method according to claim 1 wherein the conditioned one or more reference system models and the a priori model for the technical system to be configured are Gaussian processes.

4. The method according to claim 3, wherein a covariance function of the a priori model is formed from a weighted sum of covariances of the one or more reference system models and a residual covariance function, wherein adjusting the a priori model includes adjusting the residual covariance function.

5. The method according to claim 3, wherein a weight of a first reference system model of the one or more reference system models is ascertained by projecting the observations detected for the technical system to be configured onto a mean value of the first reference system model, and a weight of a second reference system model of the one or more reference system models is ascertained by projecting a residual of the observations detected for the technical system to be configured onto a mean value of the second reference system model.

6. The method according to claim 1, further comprising:
for each reference system, generating the respective reference system model by adjusting a relevant reference a priori model to the observations detected for the reference system.

7. A data processing device for configuring a technical system to be configured, the data processing device configured to:
detect, for each one or more technical reference systems, reference observations of results of the reference system for different values of configuration parameters;
condition, for each reference system, a respective reference system model for a relationship between values of the configuration parameters and results provided by the reference system on the reference observations detected for the reference system;
detect, for the technical system to be configured, observations of results of the technical system to be configured for different values of the configuration parameters;
adjust an a priori model for a relationship between values of the configuration parameters and results provided by the technical system to be configured to the observations detected for the technical system to be configured, wherein the a priori model is formed from a weighted combination of the conditioned one or more respective reference system models;
ascertain an a posteriori model for the relationship between the values of the configuration parameters and the results provided by the technical system to be configured by conditioning the adjusted a priori model on the observations detected for the technical system to be configured; and
configure the technical system to be configured using the ascertained a posteriori model.

8. A non-transitory computer-readable medium on which are stored commands for configuring a technical system to be configured, the commands, when executed by a processor, causing the processor to perform the following steps:
detecting, for each one or more technical reference systems, reference observations of results of the reference system for different values of configuration parameters;
conditioning, for each reference system, a respective reference system model for a relationship between values of the configuration parameters and results provided by the reference system on the reference observations detected for the reference system;
detecting, for the technical system to be configured, observations of results of the technical system to be configured for different values of the configuration parameters;
adjusting an a priori model for a relationship between values of the configuration parameters and results provided by the technical system to be configured to the observations detected for the technical system to be configured, wherein the a priori model is formed from a weighted combination of the conditioned one or more respective reference system models;
ascertaining an a posteriori model for the relationship between the values of the configuration parameters and the results provided by the technical system to be configured by conditioning the adjusted a priori model on the observations detected for the technical system to be configured; and
configuring the technical system to be configured using the ascertained a posteriori model.
